(19) United States
(12) Patent Application Publication
(10) Pub. No.: US 2012/0207546 A1
(43) Pub. Date: Aug. 16, 2012

(54) Apparatus for entrenching underwater pipelines

(76) Inventor: Lylyn Hingle Stockstill, New Orleans, LA (US)

(21) Appl. No.: 12/932,012

(22) Filed: Feb. 16, 2011

(51) Int. Cl. F16L 1/16

(52) U.S. Cl. 405/161

(57) ABSTRACT

An underwater trenching machine is particularly adapted to clear anodes secured on a pipeline while maintaining engagement of the propulsion assembly with the pipeline. A plurality of rollers of the propulsion assembly grippingly engages opposing sides of the pipeline. The rollers are secured on powered articulated connector arms in pairs. As the rollers come into contact with the anodes, the connector arms cause forward rollers to temporarily move out of contact with the pipeline, while remainder of the rollers maintain the contact with the pipeline. As the first pair of rollers clears the anode it returns to its normal gripping position relative to the pipeline, while the next pair of rollers moves out of engagement with the pipeline. The trenching machine also has a ballast tank and air jet assemblies mounted on the ballast tank for maintaining vertical alignment as the trenching machine moves along the pipeline.

### BACKGROUND OF THE INVENTION

This invention relates to an apparatus for entrenching submerged elongate structures and, more particularly, to a self-propelled jet sled designed for entrenching submerged pipelines.

In the energy, telecommunications and other industries, it has been a common practice to lay pipelines, cables and other types of conduits along sea beds for transporting fluids such as oil and gas and communications data from offshore rigs to a mainland. Typically, such conduits are first laid along the seabed and then are buried so as to avoid any damage to the pipeline.

Underwater equipment for burying pipeline has been well known for many years. Essentially, they incorporate some means for jetting water in advance of the movement of the apparatus to dig and cut away a trench into which the pipeline is to rest. Most previous apparatus utilize the pipeline as the guiding means for directing the apparatus in an effort to assure the positioning of the centerline of the trench to be coincident with the axis of the pipe. There usually is far less difficulty when the pipeline laying on the bottom of the body of water is in a straight line, but a serious problem occurs when the pipeline is curved or is provided with sacrificial anodes.

The conventional means for propelling such prior art trenching machines along a conduit to be buried has consisted of a set of rollers, one or more of which are adapted to be driven, usually by a hydraulic motor mounted on the machine frame. Such means of propulsion, however, has been found not to be entirely effective when the pipeline has sacrificial anodes mounted thereon. In the areas where the anodes are mounted, the pipeline is wider, while the rollers are set to frictionally engage a certain diameter pipe. The anode, therefore, forms an obstacle that can effectively disrupt the alignment of the rollers in relation to the pipeline.

An abrupt change in the direction of the roller movement will not permit the apparatus to be steered quickly enough to the new direction and the water jets will tend to continue along the straight path directly under the pipeline. The result is that the pipeline is not properly aligned with the trench. In such case, divers need to be deployed to manually re-engage the rollers of the trenching machine with the pipeline

In a typical operation for burying a conduit in a seabed, there is provided a service barge, a submersible trenching machine that is launched from the service barge. The trenching machine, or a jet sled, is attached to a plurality of umbilical lines interconnecting pumps and compressors provided on the barge and the trenching machine. Operators of such barges and machines commonly are compensated by the linear footage of conduit buried. Interruptions of the trenching operations of such machines are very costly to such operators not only because of the loss of revenue in operation of the trenching machine but also because of the cost of operating the service barge and the equipment on board.

The present invention contemplates elimination of drawbacks associated with the conventional trenching machines and provision of an improved apparatus for entrenching underwater pipelines that has a means for articulating the roller-engaging arms when the rollers encounter an obstacle, such as a sacrificial anode.

### SUMMARY OF THE INVENTION

It is, therefore, an object of the present invention to provide an apparatus for entrenching underwater pipelines.

It is another object of the invention to provide a self-propelled apparatus for entrenching underwater pipelines.

It is a further object of the invention to provide an articulated jet sled for entrenching underwater pipelines that is capable of moving the rollers toward and away from the pipeline while maintaining alignment with the pipelines.

It is still a further object of the invention to provide a jet sled that is equipped with buoyant means to facilitate alignment of the trenching machine in relation to the pipeline.

These and other objects of the invention are achieved through a provision of an underwater trenching apparatus for burying a pipeline in the sea bed. The pipeline is provided with spaced-apart enlarged portions created by clamped anodes. The apparatus comprises a control unit mounted above water surface and controlling operation of the underwater trenching unit. The trenching apparatus has a frame configured for positioning over the pipeline to be buried and a propulsion assembly mounted on the frame. The propulsion assembly comprises a plurality of rotating rollers configured to grippingly engage opposing sides the pipeline. Some of the rollers are powered drive rollers that cause advancement of the frame along the pipeline.

The rollers are carried in pairs by powered articulated connector arms that cause opposing rollers to sequentially move out of contact with the sides of the pipeline and bypass the anode while retaining gripping engagement with the sides of the pipeline by remainder of the rollers. A power unit is operationally connected to a respective connector arm. A sensor is connected to each power unit and the control unit, the sensor being configured to detect a condition when the rollers come into contact with the enlarged portion of the pipeline, generate the encountered-obstacle signal and send the signal to the control unit. The control unit processes the signal and generates a control command to the connector arms to move some of the rollers out of engagement with the pipeline.

The trenching unit also has a means supported by the frame for maintaining vertical alignment of the frame mounted on a ballast tank, which is supported by the frame. An alignment sensor is secured on each side of the ballast tank in operational relationship to an air jet assembly. When the sensor detects an out-of-alignment condition it generates a signal, which is processed by the control unit. The control unit, in turn sends a command to the air jet assemblies to expel air and return the ballast tank and the frame into a vertical position.

### BRIEF DESCRIPTION OF THE DRAWINGS

Reference will now be made to the drawings, wherein like parts are designated by like numerals, and wherein

FIG. 1 is a side view of the apparatus of the present invention illustrating the buoyancy tank and the propulsion rollers.

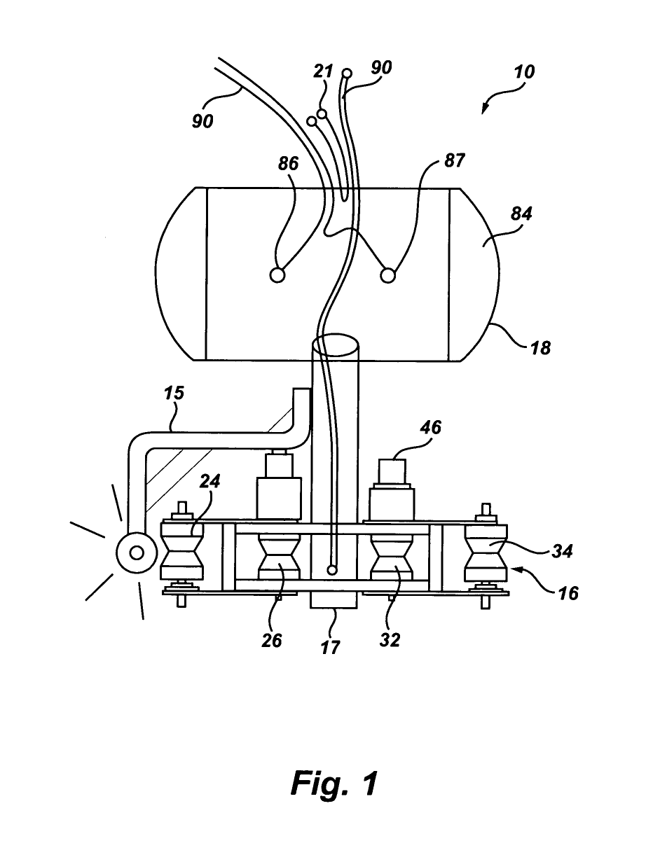

FIG. 2 is a detail top view illustrating the propulsion assembly engaged with a pipeline.

FIG. 3 is a detail end view of the entrenching apparatus of the present invention illustrating the buoyancy tank and the means for maintaining vertical orientation of the propulsion assembly.

FIG. 4 is a schematic view of the propulsion assembly of the present invention engaged with a pipeline.

FIG. 5 is a detail view illustrating the propulsion assembly and a suction nozzle.

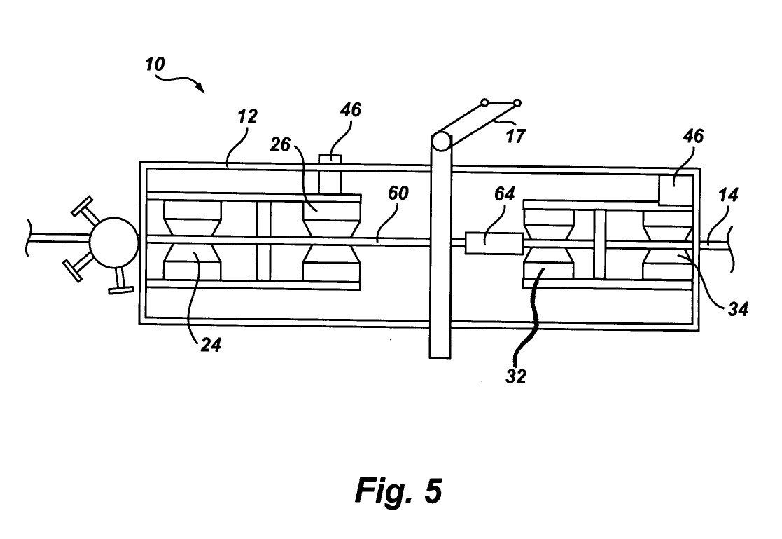

### DETAIL DESCRIPTION OF THE INVENTION

Turning now to the drawings in more detail, numeral 10 designates the apparatus for entrenching the pipeline according to the present invention. The apparatus 10 comprises a main support frame 12 adapted to straddle a pipeline 14, a propulsion assembly 16 mounted on the main support frame, a buoyancy assembly 18 mounted on the main support frame above the propulsion assembly and a means for connecting the underwater pipeline entrenching apparatus to above-surface controls. The support frame 12 supports the propulsion assembly 16, jetting device 15 and silt suction device 17. Conventionally, water under pressure or water mixed with air is delivered by a conduit 21 to a location below the pipeline 14. Jetting action by the nozzles forms a trench in the bed for receiving the pipeline 14. A rotating jetting device or jet hand 15 delivers the pressurized water/air stream and disturbs the sea bed. The displaced silt or sediment is partially removed by the suction device 17, which is connected to a hydraulic pump mounted on a service barge (not shown).

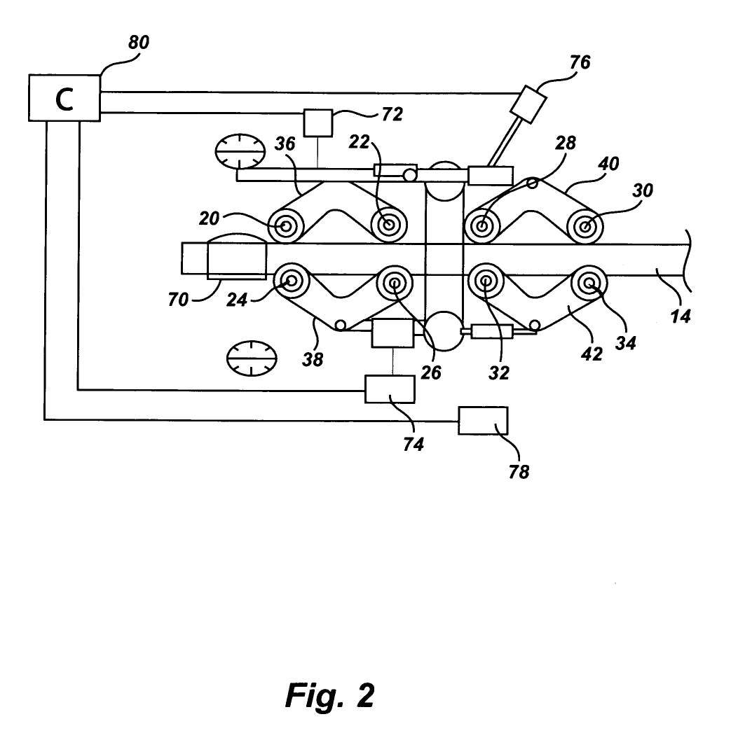

The support frame 12 is formed of a plurality of steel members welded together and strong enough to support the elements of the entrenching apparatus 10. Mounted on the frame 12 is a plurality of longitudinally spaced apart rotating rollers 20, 22, 24, 26, 28, 30, 32, and 34, which grippingly engage the sides of the pipeline 14 on diametrically opposite points. As the rollers of the propulsion assembly rotate they gradually move the frame 12 along the pipeline 14. As can be seen in FIG. 2, the rollers 22-34 are connected in opposing pairs, four pairs of rollers on each side of the pipeline 14.

Each pair of rollers is rigidly connected by articulated connector arms. Specifically, the rollers 20 and 22 are connected together by a V-shaped connector arm 36; the rollers 24 and 26 are connected by a V-shaped connector arm 38; the rollers 28 and 30 are connected by a V-shaped connector arm 40; and the rollers 32 and 34 are connected by a V-shaped connector arm 42. The rollers 22, 26 and 30, 34 are drive rollers. Each of the drive rollers is provided with separately controlled drive motor 46 operationally connected to the drive roller and causing the drive roller to move along the pipeline 14. Each drive motor 46 is connected to the surface control by suitable connector 48.

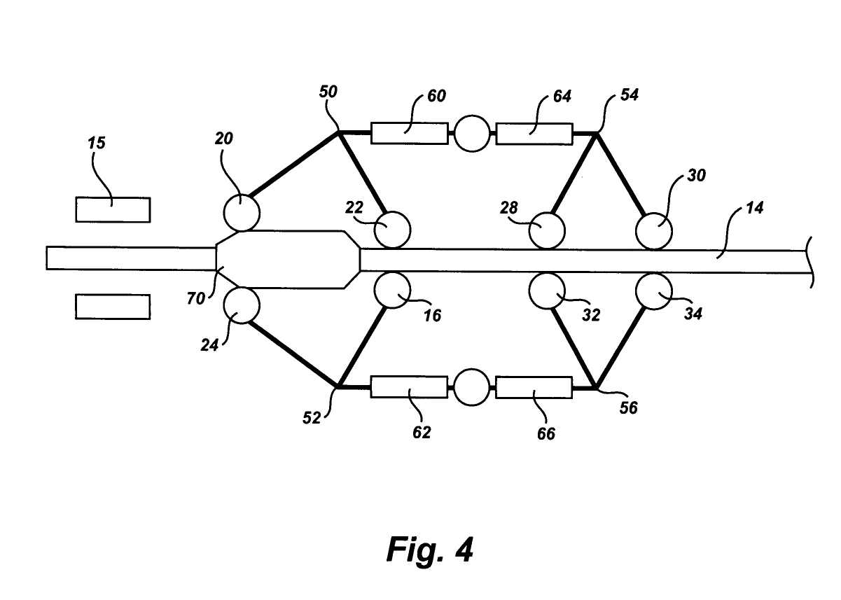

Each of the connector arms 36, 38, 40, and 42 comprises a pair of elongated arm portions unitary secured together and extending at an acute angle in relation to each other. The area of connection between the arm portions of the connector arms is schematically designated by numerals 50, 52, 54, and 56 in FIG. 4. Free ends of the arm portions carry one of the rollers 20-34.

The connector arms 36, 38, 40, and 42 are articulated arms configured to move toward and away from the pipeline 14. Each of the articulated connector arms 36, 38, 490, and 42 is provided with individually controlled power units or hydraulic rams 60, 62, 64, and 66 connected to the respective connector arms at the points of arm portion connections 50, 52, 54, and 56, respectively.

Each of the hydraulic rams 60, 62, 64, and 66 comprises a telescopically extendable piston that causes the articulated arms move toward and away from the pipeline 14. Since the rollers 20-34 are affixed to the ends of the respective articulated arms the rollers similarly are forced to move toward and away from the pipeline 14 as the apparatus 10 moves along the pipeline.

Each of the hydraulic rams 60, 62, 64, and 66 is provided with a pressure sensor configured to detect increase in pressure as the propulsion assembly with the rollers and hydraulic rams encounters an anode 70. The anode 70 is a sacrificial metal anode that is more reactive to the corrosive environment where the pipeline is laid. The anode 70 partially corrodes dissolves, which protects the metal of the pipeline by preventing it from being corroded. Such sacrificial anodes are conventional in systems where a static charge is generated by the action of flowing liquids, such as pipelines 14.

As can be seen in FIGS. 2 and 4, the anode 70, which is clamped to the pipeline 14 makes that portion of the pipeline enlarged and wider than the remainder of the pipeline. When the rollers 20-34 encounter the anode 70 the tendency of the rollers is to move away from frictional gripping engagement with the pipeline 14. Pressure sensors 72, 74, 76, and 78 are operationally connected to the hydraulic rams 60, 62, 64, and 66, respectively, to detect the increase in pressure on the rams when encountering the enlarged portions with the anodes and send a signal to a control unit 80 mounted on the service barge.

The control unit 80 processes the signal received from the sensors 72, 74, 76, and 78 sends a command to the rams to extend the pistons and sequentially move the articulated arms away from the pipeline until the rollers clear the anode 70. As soon as the rollers 30, 34 pass the obstacle formed by the anode 70 the control signal causes the piston arms to retract into the rams and return the arms and the rollers into their normal position, with the roller frictionally engaging the pipeline 14. The next set of rollers 28, 32 clears the anode 70 and returns to its original position gripping the sides of the pipeline.

As the frame 12 continues to move along the pipeline 12, the next set of rollers 22, 26, and finally of rollers 20, 24 clear the anode 70 and return to their normal frictional gripping engagement with the pipeline 14. As the opposing sets of rollers are moved out of contact with the pipeline 14, the remainder of the rollers maintains the gripping engagement with the pipeline keeping the frame 12 in alignment with the pipeline 14. If desired, the connector arms may be pivotally secured on the piston arms allowing even a greater flexibility in the movement of the connector arms relative to the line of movement of the frame 12 along the pipeline 14. Since the anodes 70 are positioned at pre-determined intervals on the pipeline 14, the process of sequential disengagement of the rollers with the enlarged portions of the pipeline 12 is repeated many times during the trenching operation.

In this manner, the alignment of the frame 12 in relation to the pipeline 14 is not interrupted and the jetting assembly 15 and the suction assembly 17 continue to be properly aligned with the pipeline 14 making the trench in the sea bed, into which the pipeline 14 is gradually lowered.

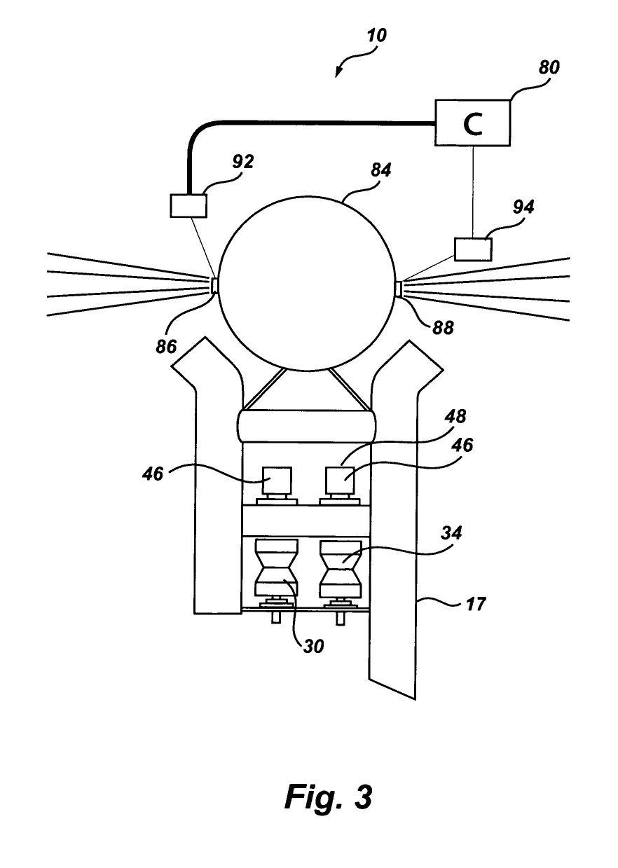

As the frame 12 moves underwater, there is a tendency of the frame to move away from a desired vertical orientation under the influence of water current. The buoyancy assembly 18 is supported by the upper part of the frame 12. The buoyancy assembly comprises an air tank 84, which has a generally cylindrical configuration. A pair of jet nozzles 86, 87 and 88, 89 is secured on each side of the tank 84 (only jet nozzle 88 can be seen in FIG. 3. It will be understood that the jet nozzle 89 is located on the same side of the tank 84 is diametrically opposite position to the jet nozzle 87.

The jet nozzles 86, 87, 88, and 89 is each connected to an air manifold 90, which delivers pressurized air to the jet nozzles. Each manifold 90 is connected through an air hose forming part of the umbilical cord, to a compressor provided on the service barge. In the conventional manner, compressed air may be supplied to or vented from the buoyancy tanks to control the buoyancy effect of the tanks.

A vertical position or alignment sensor 92, 94 is secured on each side of the tank 84. The sensors 92 and 94 are configured to detect an out-of-alignment position of the buoyancy tank 84, along with the frame 12 and send a signal to the control panel 80. The control unit 80 processes the signals received from the alignment sensors 92 and 94 and sends a command signal to the air delivery system to open the nozzles 86, 87 or 88, 89 on either side of the tank 84 and realign the trenching apparatus 10 along the vertical axis.

The apparatus of the present invention saves considerable amount of time for the operator since there is no interruption in the movement of the trenching machine dues to the anode presence. The articulated propulsion roller assemblies easily pass the anodes and continue moving the trenching machine along the pipeline. The jetting nozzles mounted on the buoyancy tank retain the trenching machine in a vertical orientation thus facilitating creation of an even aligned trench.

Many changes and modifications can be made in the design of the present invention without departing from the spirit thereof. I, therefore, pray that my rights to the present invention be limited only by the scope of the appended claims.

I claim:

1. An underwater trenching apparatus for burying a pipeline with spaced apart enlarged size portions beneath the bottom of a body of water, the apparatus comprising:
a frame configured for positioning over the pipeline to be buried;
a propulsion assembly mounted on said frame, said propulsion assembly comprising a plurality of rotating rollers configured to grippingly engage opposing sides the pipeline, said rollers being carried in pairs by articulated connector arms, said connector arms causing opposing rollers to sequentially move out of contact with the sides of the pipeline and bypass the enlarged portions while retaining gripping engagement with the sides of the pipeline by remainder of the rollers.

2. The apparatus of claim 1, wherein at least some of said rollers are powered rollers configured to advance the frame along the pipeline.

3. The apparatus of claim 1, wherein said propulsion assembly further comprises a power unit operationally connected to a respective connector arm and a sensor connected to each power unit, said sensor being configured to detect a condition when the rollers come into contact with the enlarged portion of the pipeline.

4. The apparatus of claim 3, further comprising a control unit configured to receive a signal from each sensor, process the signal and command each of the connector arms to articulate and temporarily move the rollers carried by said connector arms out of engagement with the enlarged portion of the pipeline.

5. The apparatus of claim 3, wherein each of the connector arms has a generally V-shaped configuration and comprises a pair of unitary connected elongated arm portions, a free end of each of said elongated arm portions carrying a roller.

6. The apparatus of claim 5, wherein said power unit is secured to an apex of the V-shaped connector arm.

7. The apparatus of claim 1, further comprising a ballast tank supported by the frame above said propulsion assembly.

8. The apparatus of claim 7, wherein said tank carries a means for maintaining vertical alignment of the frame.

9. The apparatus of claim 8, wherein said means for maintaining vertical alignment comprises at least one alignment jet assembly mounted on each of opposing sides of the ballast tank, said alignment jet assembly being configured to expel pressurized air upon detection of an out-of-alignment condition and cause movement of the ballast tank relative to a vertical axis.

10. The apparatus of claim 9, wherein said means for maintaining vertical alignment further comprises a sensor mounted on each side of the ballast tank and operationally connected to a respective alignment jet assembly, said sensor being configured to detect the out-of-alignment condition and cause the air to be expelled from the alignment jet assembly on one or another side of the ballast tank.

11. An underwater trenching apparatus for burying a pipeline with spaced apart enlarged size portions beneath the bottom of a body of water, the apparatus comprising:
a control unit mounted above water surface;
a frame configured for positioning over the pipeline to be buried;
a propulsion assembly mounted on said frame, said propulsion assembly comprising a plurality of rotating rollers configured to grippingly engage opposing sides the pipeline, said rollers being carried in pairs by articulated connector arms, said connector arms causing opposing rollers to sequentially move out of contact with the sides of the pipeline and bypass the enlarged portions while retaining gripping engagement with the sides of the pipeline by remainder of the rollers;
a power unit operationally connected to a respective connector arm and a sensor connected to each power unit and the control unit, said sensor being configured to detect a condition when the rollers come into contact with the enlarged portion of the pipeline; and
a means supported by the frame for maintaining vertical alignment of the frame.

12. The apparatus of claim 11, wherein said control unit is configured to receive a signal from each sensor, process the signal and command each of the connector arms to articulate and temporarily move the rollers carried by said connector arms out of engagement with the enlarged portion of the pipeline.

13. The apparatus of claim 11, wherein each of the connector arms has a generally V-shaped configuration and comprises a pair of unitary connected elongated arm portions, a free end of each of said elongated arm portions carrying a roller.

14. The apparatus of claim 13, wherein said power unit is secured to an apex of the V-shaped connector arm.

15. The apparatus of claim 11, further comprising a ballast tank supported by the frame above said propulsion assembly.

16. The apparatus of claim 11, wherein said means for maintaining vertical alignment comprises at least one alignment jet assembly mounted on each of opposing sides of the ballast tank, said alignment jet assembly being configured to expel pressurized air upon detection of an out-of-alignment condition and cause movement of the ballast tank relative to a vertical axis.

17. The apparatus of claim 16, wherein said means for maintaining vertical alignment further comprises an alignment sensor mounted on each side of the ballast tank and operationally connected to a respective alignment jet assembly and the control unit, said alignment sensor being configured to detect the out-of-alignment condition, generate an out-of-alignment signal and transmit the out-of-alignment signal to the control unit, said control unit sending a command signal to said at least one alignment jet assembly and causing the air to be expelled from the alignment jet assembly on one or another side of the ballast tank.

18. The apparatus of claim 11, wherein at least some of said rollers are drive rollers provided with a motor and configured to advance the frame along the pipeline.

19. A method of entrenching an underwater pipeline having spaced apart enlarged portions beneath the bottom of a body of water, the method comprising the steps of:
providing a control unit mounted above water surface;
providing a frame configured for positioning over the pipeline to be buried;
providing a propulsion assembly mounted on said frame, said propulsion assembly comprising a plurality of rotating rollers configured to grippingly engage opposing sides the pipeline, said rollers being carried in pairs by articulated connector arms;
positioning said frame over the pipeline and moving the rollers into a gripping engagement with the opposing sides of the pipeline;
causing the frame to move along the pipeline while creating a trench under the pipeline;
detecting an enlarged portion on the pipeline and temporarily sequentially moving opposing pairs of the rollers out of contact with the sides of the pipeline, thereby bypassing the enlarged portion while retaining gripping engagement with the sides of the pipeline by remainder of the rollers.

20. The method of claim 19, further comprising a step of providing a power unit for each of said connector arms and providing a sensor connected to each power unit and the control unit.

21. The method of claim 20, further comprising a step of detecting a condition when the rollers come into contact with the enlarged portion of the pipeline, generating a signal of encountered contact with the enlarged portion of the pipeline, transmitting the generated signal to the control unit, and generating a command signal to the connector arms to sequentially move the rollers out of engagement with the pipeline.

22. The method of claim 19, further comprising a step of providing a ballast tank supported by the frame and a means for maintaining vertical alignment of the frame.

23. The method of claim 22, further comprising a step of securing at least one alignment jet assembly on each of opposing sides of the ballast tank, detecting an out-of-alignment condition of the frame and causing said at least one alignment jet assembly to expel pressurized air, thereby returning said frame to a vertical alignment.

24. The method of claim 23, further comprising a step of providing an alignment sensor mounted on each side of the ballast tank and operationally connected to a respective alignment jet assembly and the control unit, said alignment sensor being configured to detect the out-of-alignment condition, generate an out-of-alignment signal and transmit the out-of-alignment signal to the control unit, said control unit sending a command signal to said at least one alignment jet assembly and causing the air to be expelled from the alignment jet assembly on one or another side of the ballast tank.
